(19) United States
(12) Patent Application Publication
(10) Pub. No.: US 2018/0297684 A1
(43) Pub. Date: Oct. 18, 2018

(54) High Altitude Aerostat, Zeppelin, Blimp, Airship with External Autonomous Balloon, Ballonets and System for Air Buoyancy Control

(71) Applicant: dragan nikolic, holiday, FL (US)

(72) Inventor: dragan nikolic, holiday, FL (US)

(73) Assignee: Dragan Nikolic, holiday, FL (US)

(21) Appl. No.: 15/488,466

(22) Filed: Apr. 15, 2017

(51) Int. Cl. B64B 1/50; B64B 1/36; B64B 1/06

(52) U.S. Cl. CPC B64B 1/50; B64B 1/06; B64B 1/36

(57) ABSTRACT

A high altitude aerostat with external autonomous ballonets is disclosed. The invention being comprised of rigid, semi rigid and nonrigid airships of varying sizes, filled with lift gas and being able to traverse the stratosphere and the lower mesosphere. Said airship being controlled remotely or on board and having rotating thrusters powered by solar panels affixed to the envelope sides. In the stratosphere, the rigid aerostat withstands turbulence during travel. In the lower mesosphere, onboard microcontrollers and processors have the ability to deploy and charge said external ballonets with lift gas. An onboard compressor vents said ballonets and stores gas inside onboard bottles. An additional remotely-controlled satellite aerostat can link up with said airship and provide additional compressor capabilities in lower pressure elevations. The aforementioned invention can be utilized as a long-term surveillance and reconnaissance platform or provide a means for human and cargo transportation and storage.

### FIELD OF THE INVENTION

The present invention generally relates to high altitude aerostats. More particularly, the invention relates to high altitude, rigid, low-propulsion airships having external, non-rigid balloons to facilitate automated ballonets for buoyancy control.

### BACKGROUND

An aerostat, also known as an airship, is a type of lighter-than-air aircraft that can navigate under its own power. Aerostats gain lift from large bag envelopes filled with a lifting gas (usually helium) that is less dense than the surrounding air. Aerostats can also have engines, crews, and payload accommodations, typically inside gondolas suspended below the envelope. The main types of aerostats include non-rigid, semi-rigid, and rigid. Non-rigid aerostats are balloons that rely on internal pressure to maintain shape. Semi-rigid aerostats have supporting structures attached to it. Rigid aerostats have an outer structural framework which maintains the shape and the lifting gas is contained in one or more internal gas bags or cells. Aerostats were the first aircraft to achieve powered flight but were surpassed by the invention of the aeroplane a few decades later.

Today, aerostats are mostly used by governments to gather long-range intelligence and conduct high-level surveillance missions. Aerostat construction continues to develop as engineers design hybrid air vehicles and develop a long endurance aerostats known as ‘multi-intelligence vehicles.’ Several designers have created aerostats with multiple ballonets that can be deployed in the tranquil mesosphere. U.S. Pat. No. 8,061,647B1 granted to Powell disclosed a high altitude airship consisting of two large ballonets. U.S. Patent No. 20070029448A1 also granted to Powell disclosed a system of airships and docking stations to facilitate high altitude travel. U.S. Pat. No. 6,843,448B2 granted to Parmley disclosed an airship having dual rigid ballonets for high altitude transport. U.S. Patent No. 20120037748A1 granted to Schneider disclosed a tri-hulled rigid airship. U.S. Pat. No. 8,894,002B2 granted to Goelet disclosed a rigid, high altitude airship having solar panels to drive propulsion motors. While many existing aerostats in the prior art combine rigid, semi rigid, and nonrigid ballonets for traveling in both the stratosphere and mesosphere, few have been found that incorporate solar panels and low-power propulsion systems. The foregoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in the prior art through the disclosure of both small and large scale aerostats that can maneuver both in the stratosphere as well as into the lower mesosphere.

Another object of the invention is to provide a means for high altitude, human and cargo transportation in both the stratosphere and the lower mesosphere.

An object of the aforementioned invention is to enhance the capability of aerostats to travel in the stratosphere by means of a rigid airship that can withstand winds associated with this altitude and then continue on into the lower mesosphere by deploying additional, non-rigid external ballonets above the airship.

Another object of the aforementioned invention is to enhance airship control in the mesosphere through low-powered thrusters that can independently pivot in multiple directions.

Another object of the aforementioned invention is to provide inexpensive power to thrusters through solar panels mounted along the sides of the rigid portion of the aerostat.

Another object of the invention is to store electrical power from said solar cells through the use of onboard batteries.

Another object of the invention is to connect the rigid airship to the external ballonets by means of cables that pass through said rigid airship envelope.

Another object of the invention is to provide additional buoyancy control by filling and venting lift gas to and from external ballonets by means of rigid tubes connected to the tops of said ballonets and to the said tanks. Vented gas is reintroduced to the tanks by means of an onboard high-pressure compressor.

Another object of the invention is to provide a means for filling and venting ballonets automatically by means of onboard storage bottles having regulators connected to solenoids controlled by microprocessors. Ballonets also include resistance-based, tension trigger gauges that measure the amount of gas in each envelope as well as pressure sensors.

Another object of the invention is to provide a means to boost onboard compressor capacity at in the lower mesosphere through a satellite airship with a more powerful, gasoline powered compressor that will hook up to the existing compressor while in flight to provide additional lift gas to lift gas storage bottles.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 is a perspective view of the invention having differing size embodiments.

FIG. 2 is a side perspective view of the invention.

FIG. 3 is a side view of the invention's gondola.

FIG. 4 is a front view of the invention.

FIG. 5 is a diagram of lifting gas lines.

FIG. 6 is a perspective view of the invention with satellite compressor booster ballonet.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

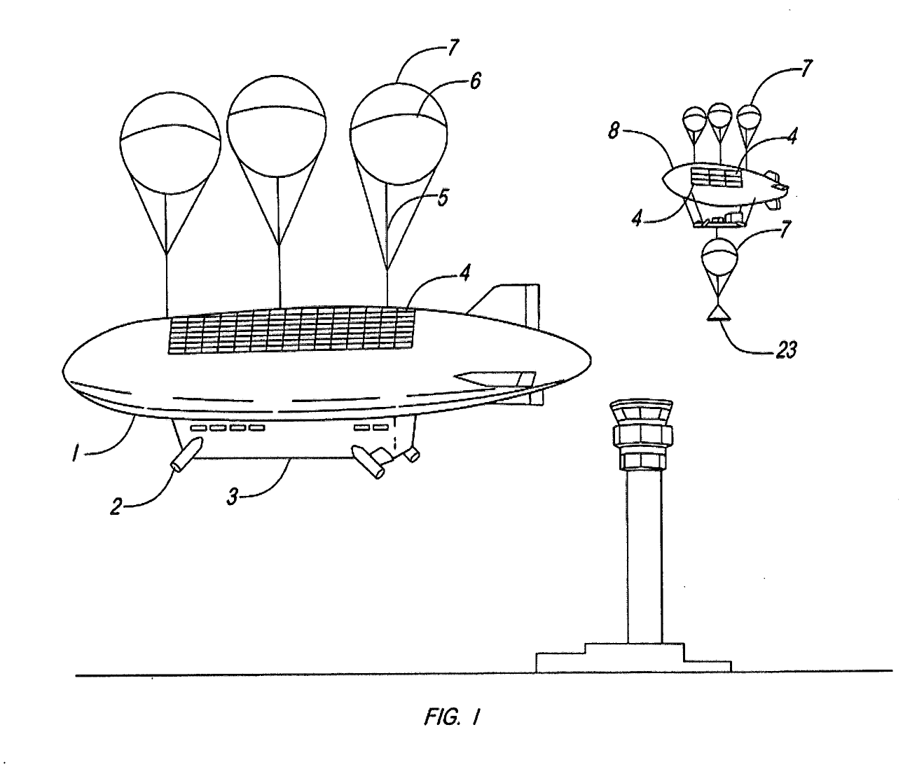

FIG. 1 showing a perspective view of the invention having different sizes 1 and 8. The aforementioned invention being comprised of semi-rigid, rigid, and nonrigid type aerostats, airships and dirigibles and the like and having at least, but not limited to, three external ballonets 7. Said aerostat envelope 1 comprised of flexible materials such as, but not limited to dacron, polyester and Mylar etc. therein and having a gondola 3 operatively connected to aerostat 1 by means of rigid cables (made of metal and the like). Said gondola 3 being rectangular in shape, comprised of a lightweight, rigid frame constructed of aluminum etc. and being disposed parallel to the longitudinal axis of said invention. Said gondola having a plurality of structures such as pilot compartments, cargo holds, observation decks, mechanical rooms and passenger seating areas. Upper portions of said aerostat envelope having a plurality of solar panels distally affixed thereon and operatively connected to batteries 12 onboard said gondola 3 thereon.

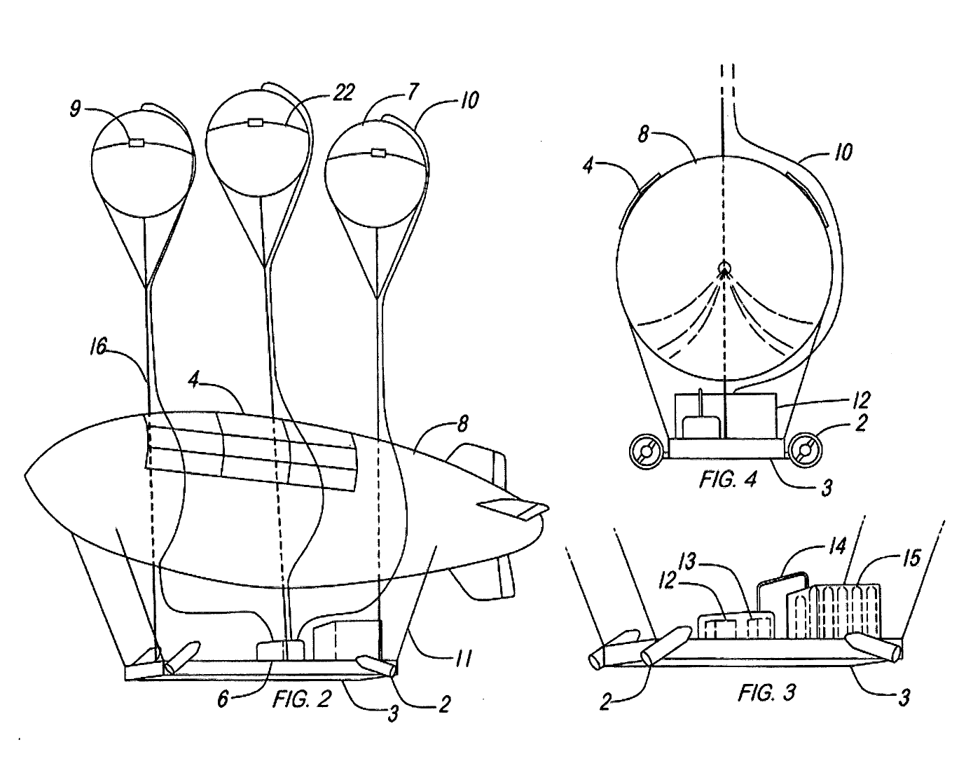

FIG. 2 showing a side view of the invention having suspension cables 16 comprised of rigid metal wire such as wound steel etc. connecting external ballonets 7 to gondola 3 and passing through aerostat 1. The aforementioned gondola 3 also having a multitude of thrusters 2 configured along the perimeter of said gondola 3. Said thrusters comprised of a propellor and shroud and being affixed to an axle connected to gondola 3 and being able to rotate 360 degrees. Thrusters 2 also being powered by batteries located in compartment 6 therewith. FIG. 2 also showing external ballonets 7 having tension sensors 9 affixed to ballonet slings 22 (constructed of an elastic polymer and the like) measuring lifting gas volume of said ballonets 7 therein.

FIG. 3 showing a closeup side view of the invention's gondola 3 having onboard battery cache 12 (comprised of lithium ion and nickel hydride cells and the like), onboard lifting gas compressor and lift gas bottle 15 storage bay being operatively connected by means of conduit 14.

FIG. 4 showing a front view of the invention and thruster 2 propellers and said photovoltaic panels 4 affixed to said airship envelope 8.

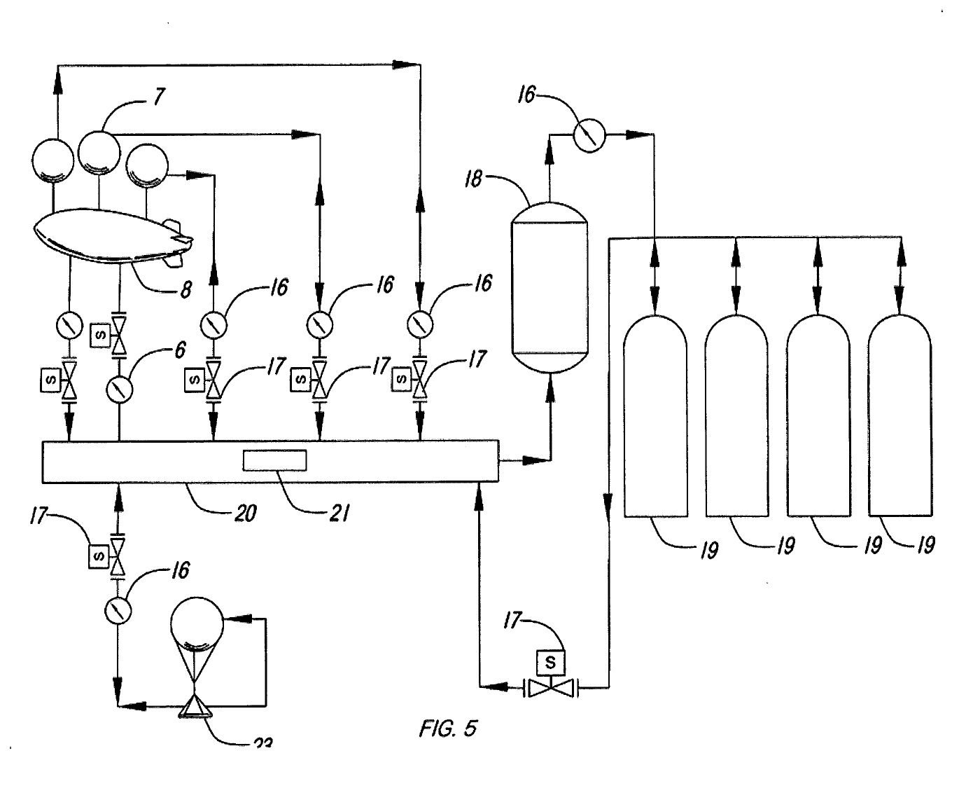

FIG. 5 showing a line diagram of the onboard automated buoyancy process whereby central manifold 20 being operatively connected to microprocessor 21 (also powered by batteries 12). Said processor 21 comprised of a PLC or SCADA controller and the like and providing commands to said thrusters 2 while also interacting with solenoids 17 and pressure sensors 16. Said microprocessor also having GPS location, storage recording and transmission capabilities. Onboard lifting gas bottles 19 supplying said ballonets 7 with lift gas as needed by means of solenoids 17 controlled by microprocessor 21. Said microprocessor 21 may also be controlled remotely by ground support through radio and cellular communication methods and the like. Buoyancy regulation also being governed by lift gas being automatically vented from said ballonets 7 by means of a rigid tube (made of a rigid plastic material etc.) extending along said cable 16 and entering ballonets 7 inside a sealed aperture (FIG. 2). Another end of said tube 16 being connected to lines with combinations of solenoids 17 and pressure sensors 16 and being recompressed by means of compressor 18 and conveyed back into storage bottles 19. FIG. 5 also showing booster satellite ballonet 23 connecting into said manifold 20.

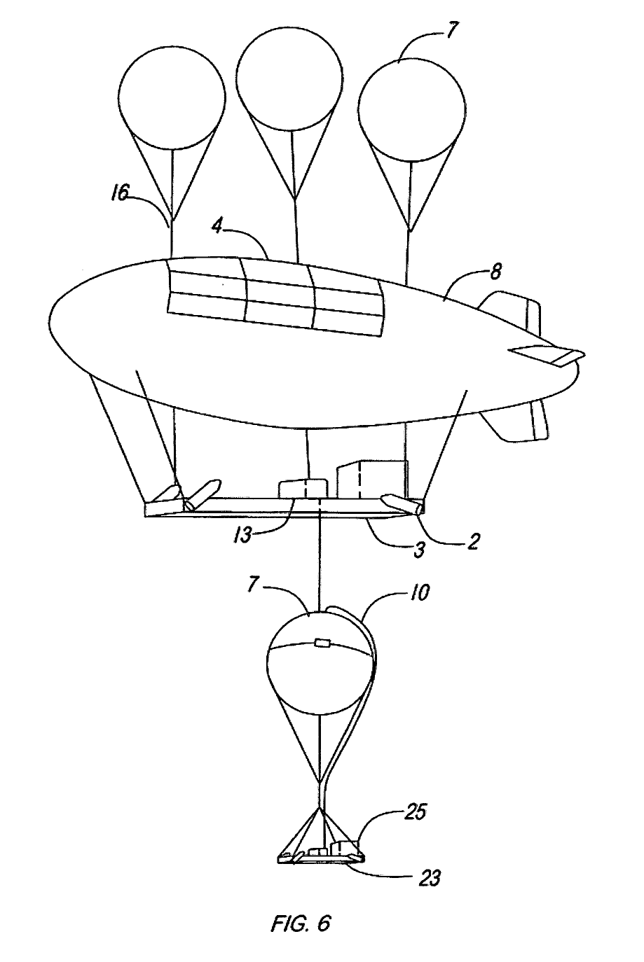

FIG. 6 showing the aforementioned invention situated next to a satellite compressor booster ballonet 23. Said booster ballonet 23 having similar features of the aforementioned invention (thrusters, ballonets, batteries, gondola, compressor, microprocessor etc.) and may be remotely controlled. However compressor 25 being comprised of a much powerful gasoline-powered compressor and being selectively coupled to compressor 13 by means of a flexible yet rigid hose apparatus 24 made of rubber and the like.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A high altitude aerostat with external autonomous ballonets.

2. The device of claim one providing both small and large scale aerostats that can maneuver both in the stratosphere as well as into the lower mesosphere

3. The device of claim one providing a means for high altitude, human and cargo transportation in both the stratosphere and the lower mesosphere.

4. The device of claim one providing a capability to travel in the stratosphere by means of a rigid airship that can withstand winds associated with this altitude and then continue on into the lower mesosphere by deploying additional, non-rigid external ballonets above the airship.

5. The device of claim one providing an enhanced airship control in the mesosphere through low-powered thrusters that can independently pivot in multiple directions.

6. The device of claim one providing recording assemblies within easy reach of those using the device on a side of said device.

7. The device of claim one providing inexpensive power to thrusters through solar panels mounted along the sides of the rigid portion of the aerostat.

8. The device of claim one providing storage of electrical power from solar cells through the use of onboard batteries.

9. The device of claim one providing a mans for connecting the rigid airship to the external ballonets by means of cables that pass through said rigid airship envelope.

10. The device of claim one providing additional buoyancy control by filling and venting lift gas to and from external ballonets by means of rigid tubes connected to the tops of said ballonets and to the said tanks. Vented gas is reintroduced to the tanks by means of an onboard high-pressure compressor.

11. The device of claim one providing a means for filling and venting ballonets automatically by means of onboard storage bottles having regulators connected to solenoids controlled by microprocessors. Ballonets also include resistance-based, tension trigger gauges that measure the amount of gas in each envelope.

12. The device of claim one providing a means to boost onboard compressor capacity at in the lower mesosphere through a satellite airship with a more powerful, gasoline powered compressor that will hook up to the existing compressor while in flight to provide additional lift gas to storage bottles.
